(19) United States
(12) Patent Application Publication
(10) Pub. No.: US 2019/0040166 A1
(43) Pub. Date: Feb. 7, 2019

(54) LIQUID QUALITY DETECTING DEVICE WITH INBUILT LIQUID BLOCKING FUNCTION

(71) Applicant: HON HAI PRECISION INDUSTRY CO., LTD., New Taipei (TW)

(72) Inventor: HSIU-WEN CHIEN, New Taipei (TW)

(21) Appl. No.: 15/688,998

(22) Filed: Aug. 29, 2017

(30) Foreign Application Priority Data
Aug. 2, 2017 (TW) 106126035

(51) Int. Cl. C08F 120/06; C09D 123/04; C02F 1/00; B08B 9/02

(52) U.S. Cl. CPC C08F 120/06; B08B 9/02; C02F 1/00; C09D 123/04

(57) ABSTRACT

A liquid quality detecting device includes a spherical frame and a hydrogel ball received in the spherical frame. The hydrogel ball can be in an original state or an expanded state. In the original state, an inner diameter of the spherical frame is greater than an outer diameter of the hydrogel ball, thereby defining a channel allowing the liquid to pass. The hydrogel ball is made of hydrogel which is pH-sensitive. When the pH value of the liquid is greater than a preset pH range, the hydrogel ball expands, and the core layer expands to cause the outer diameter of the hydrogel ball to become equal to the inner diameter of the spherical frame, thereby causing the hydrogel ball to block the channel. When in contact with within-range liquid again, the hydrogel ball reverts to original size.

### FIELD

The subject matter herein generally relates to liquid quality detection, and more particularly, to a liquid quality detecting device with inbuilt liquid blocking function.

### BACKGROUND

Many factories generate waste water which may be harmful to the environment. Thus, it is needed to detect the quality of the waste water before putting the waste water into the environment. However, existing detection devices for detecting the waste water are large in size and not easy to carry.

Furthermore, the quality of the waste water is not constant and usually varies. When the detection device detects that the quality of the waste water does not meet the standard, a user needs to install a blocking device manually to prevent the waste water from polluting the environment. When the detection device detects that the quality of the waste water meets the standard, the user needs to remove the blocking device. This decreases the working efficiency. Improvement in the art is preferred.

### BRIEF DESCRIPTION OF THE DRAWINGS

Implementations of the present technology will now be described, by way of example only, with reference to the attached figures.

FIG. 1 is a diagram of an exemplary embodiment of a liquid quality detecting device with inbuilt liquid blocking function.

FIG. 2 is similar to FIG. 1, but showing the liquid quality detecting device in another state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

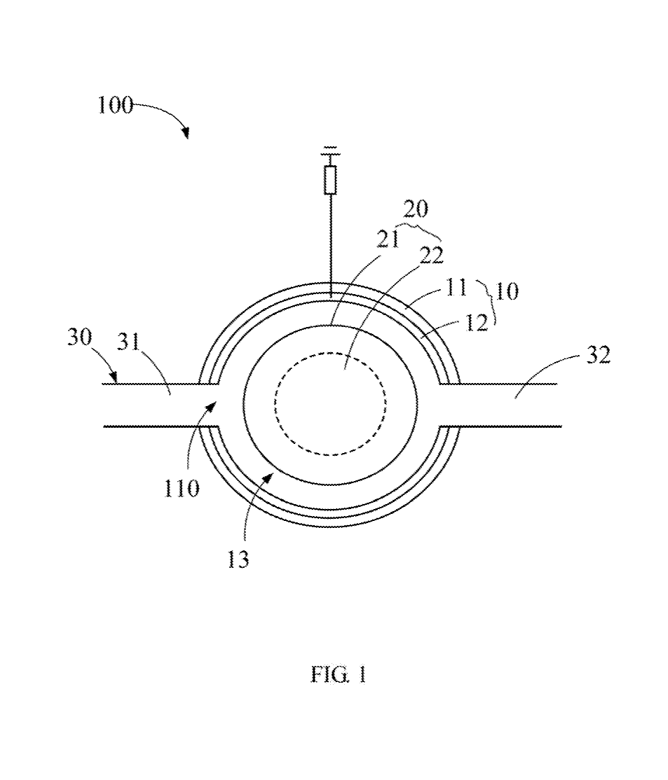

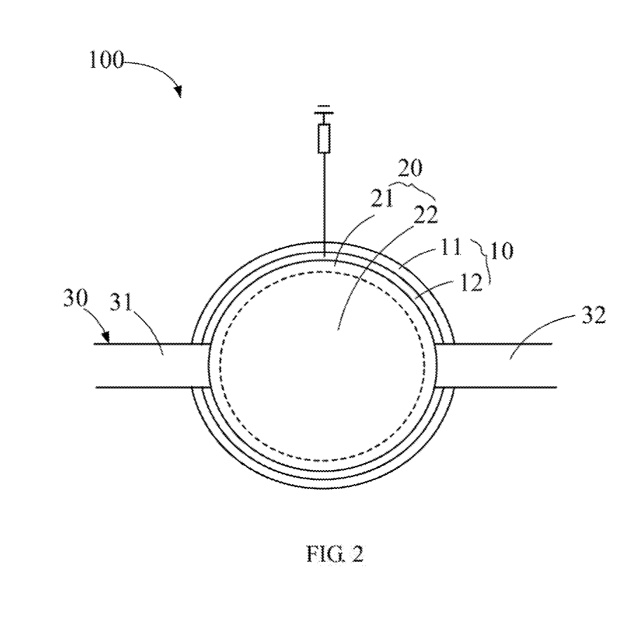

FIGS. 1 and 2 illustrate an exemplary embodiment of a liquid quality detecting device 100 with inbuilt liquid blocking function. The device 100 can detect a pH value of a liquid (for example, waste water discharged by or service water used by a factory) flowing through the device 100, and prevent the liquid from flowing as long as the detected pH value is greater than a preset pH range. The device 100 comprises a hollow spherical frame 10 and a hydrogel ball 20 received in the spherical frame 10. The device 100 can further comprise a draining pipe 30 connected to the spherical frame 10.

The hydrogel ball 20 can change between an original state (see FIG. 1) and an expanded state (see FIG. 2). When the hydrogel ball 20 is in its original state, an inner diameter of the spherical frame 10 is greater than an outer diameter of the hydrogel ball 20, thereby defining a channel 13 between the spherical frame 10 and the hydrogel ball 20 and surrounding the hydrogel ball 20. In at least one exemplary embodiment, the spherical frame 10 comprises a spherical wall 11 and an electrode layer 12 attached to an inner surface of the spherical wall 11. The spherical wall 11 can be made of plastic. The electrode layer 12 can be made of metal (such as aluminum). The spherical wall 11 defines two openings 110 at the two opposite ends. The openings 110 are connected to an inlet section 31 and an outlet section 32 of the draining pipe 30. The draining pipe 30 communicates with the channel 13 through the openings 110.

The hydrogel ball 20 comprises a wrapping layer 21 and a core layer 22 received in the wrapping layer 21. The wrapping layer 21 is made of polyfluortetraethylene (PTFE). The core layer 22 is made of hydrogel which is pH-sensitive.

When the liquid flows into the channel 13 through the inlet section 31 and the pH value of the liquid falls within the preset pH range, the hydrogel ball 20 maintains its original state. The flowing liquid pushes the hydrogel ball 20 to cause the hydrogel ball 20 to roll in the spherical frame 10. Thus, the wrapping layer 21 of the hydrogel ball 20 contacts the electrode layer 12 of the spherical frame 10, and a triboelectric effect happens. Then, electrical energy is generated which can be directed to an external device (not shown) through wires connected to the electrode layer 12. In at least one exemplary embodiment, the wrapping layer 21 generates negative electric charges, and the electrode layer 12 generates positive charges.

When the pH value of the liquid is greater than the preset pH range, since the core layer 22 is pH-sensitive (the liquid can penetrate into the hydrogel ball 20 through the wrapping layer 21), the hydrogel ball 20 can change from the original state to the expanded state. That is, the core layer 22 of the hydrogel ball 20 expands to cause the outer diameter of the hydrogel ball 20 to be greater than or equal to the inner diameter of the spherical frame 10. Then, the hydrogel ball 20 can block the channel 13 and prevent the liquid from flowing through the outlet section 32. Thus, when the pH value of the liquid is greater than the permitted standard, the hydrogel ball 20 can block the channel 13 and prevent the liquid from flowing through the device 100. When the pH value of the liquid falls back within the preset pH range, the hydrogel ball 20 returns to its original state.

In at least one exemplary embodiment, the core layer 22 is made of zwitterionic hydrogel. For example, the core layer 22 comprises two polyelectrolyte hydrogels having different acid dissociation constants (pka).

In at least one exemplary embodiment, the core layer 22 comprises polyacrylic acid (PAC, chemical diagram:

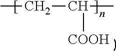

and polyallylamine (PAA, chemical diagram:

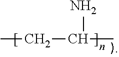

The polyacrylic acid has an acid dissociation constant of 4.5 (pka=4.5). The polyallylamine has an acid dissociation constant of 9.6 (pka=9.6). When the pH value is greater than or equal to 4.5 (pH≥4.5), the polyacrylic acid comprises negative charges (—COO⁻). When pH value is less than or equal to 9.6 (pH≤9.6), the polyallylamine comprises positive charges (—NH₃⁺). When the pH value is less than 4.5 (pH<4.5), the polyacrylic acid comprises no charges. When the pH value is greater than 9.6 (pH>9.6), the polyallylamine comprises no charges.

The preset pH range satisfies: 4.5≤pH≤9.6. When the pH value of the liquid falls within the preset pH range, the polyacrylic acid comprises negative charges and the polyallylamine comprises positive charges. Thus, the polyacrylic acid and the polyallylamine cooperatively form a static electrical balance. When the pH value of the liquid is less than 4.5, the polyacrylic acid comprises no charges and the polyallylamine comprises positive charges. Thus, the repelling force between the positive charges causes the hydrogel ball 20 to expand. When the pH value of the liquid is greater than 9.6, the polyacrylic acid comprises negative charges and the polyallylamine comprises no charges. Thus, the repelling force between the negative charges also causes the hydrogel ball 20 to expand. When the pH value of the liquid falls within the preset pH range again, the polyacrylic acid and the polyallylamine cooperatively form the static electrical balance again, which returns the hydrogel ball 20 to its original state.

In another exemplary embodiment, the core layer 22 comprises hyaluronic acid and chitosan. The hyaluronic acid has an acid dissociation constant of 3.2 (pka=3.2). The chitosan has an acid dissociation constant of 6.5 (pka=6.5). The preset pH range satisfies: 3.2≤pH≤6.5.

With the above configuration, the device 100 has a pH detecting function and a liquid blocking function. When the pH value of the liquid is outside the permitted standard, the hydrogel ball 20 expands and prevents the liquid from flowing through the device 100. When the pH value of the liquid meets the permitted standard, the hydrogel ball 20 continues or returns to its original state and allows the liquid to flow through the device 100. The device 100 is simple in structure and easy to carry.

Furthermore, the device 100 can collect electrical energy when the hydrogel ball 20 is rolling and in contact with the spherical frame 10. Thus, the device 100 can function as a triboelectric nanogenerator.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A liquid quality detecting device with inbuilt liquid blocking function, comprising:
a hollow spherical frame; and
a hydrogel ball received in the spherical frame, the hydrogel ball capable of changing between an original state and an expanded state;
wherein, when the hydrogel ball is in its original state, an inner diameter of the spherical frame is greater than an outer diameter of the hydrogel ball, thereby defining a channel between the spherical frame and the hydrogel ball and surrounding the hydrogel ball, the hydrogel ball comprises a core layer, the core layer is made of hydrogel which is pH-sensitive;
wherein, when the pH value of the liquid flowing through the channel is greater than a preset pH range, the hydrogel ball changes to the expanded state, when the hydrogel ball is in the expanded state, the core layer expands to cause the outer diameter of the hydrogel ball to be greater than or equal to the inner diameter of the spherical frame, thereby causing the hydrogel ball to block the channel, the hydrogel ball returns to the original state when the pH value of the liquid falls within the preset pH range.

2. The liquid quality detecting device of claim 1, wherein the spherical frame comprises a spherical wall and an electrode layer attached to an inner surface of the spherical wall, when the pH value of the liquid falls within the preset pH range and the liquid flowing in the channel pushes the hydrogel ball to roll in the spherical frame, the electrode layer generates positive charges.

3. The liquid quality detecting device of claim 2, wherein the hydrogel ball further comprises a wrapping layer wrapping the core layer, the wrapping layer generates negative electric charges when the liquid flowing in the channel pushes the hydrogel ball to roll in the spherical frame.

4. The liquid quality detecting device of claim 3, wherein the wrapping layer is made of polyfluortetraethylene, and the electrode layer is made of metal.

5. The liquid quality detecting device of claim 2, wherein the spherical wall is made of plastic.

6. The liquid quality detecting device of claim 2, further comprising a draining pipe connected to the spherical frame.

7. The liquid quality detecting device of claim 6, wherein the draining pipe comprises an inlet section and an outlet section, the spherical wall defines two openings at two opposite ends, the openings are connected to the inlet section and the outlet section, thereby allowing the draining pipe to communicate with the channel through the openings.

8. The liquid quality detecting device of claim 1, wherein the core layer comprises two polyelectrolyte hydrogels having different acid dissociation constants.

9. The liquid quality detecting device of claim 8, wherein the core layer comprises polyacrylic acid and polyallylamine, the polyacrylic acid has an acid dissociation constant of 4.5, the polyallylamine has an acid dissociation constant of 9.6, the preset pH range satisfies: 4.5≤pH≤9.6.

10. The liquid quality detecting device of claim 8, wherein the core layer comprises hyaluronic acid and chitosan, the hyaluronic acid has an acid dissociation constant of 3.2, the chitosan has an acid dissociation constant of 6.5, the preset pH range satisfies: 3.2≤pH≤6.5.
